(19) United States
(12) Patent Application Publication
(10) Pub. No.: US 2012/0253913 A1
(43) Pub. Date: Oct. 4, 2012

(54) METHOD, SYSTEM AND DEVICE FOR EXECUTING A MOBILE TRANSACTION

(76) Inventor: Postrel Richard, Miami Beach, FL (US)

(21) Appl. No.: 13/337,010

(22) Filed: Dec. 23, 2011

Related U.S. Application Data
(60) Provisional application No. 61/470,690, filed on Apr. 1, 2011.

(51) Int. Cl. G06Q 30/02; G06Q 20/36; G06Q 20/40; G06Q 20/20

(52) U.S. Cl. 705/14.27

(57) ABSTRACT

A method of and system for a user executing a mobile transaction. A virtual wallet is generated on a mobile device, the mobile wallet including a reward value component. Information about an item desired to be purchased by the user is input to the mobile device. A proposed payment solution is generated from the virtual wallet that is sufficient to pay for the item and then presented to a point of sale terminal. The point of sale terminal then executes instructions from the proposed payment solution sufficient to execute payment for the item.

### CROSS-REFERENCE TO RELATED APPLICATIONS

This application claims the benefit of U.S. provisional application 61/470,690, filed on Apr. 1, 2011, REWARD EXCHANGE METHOD AND SYSTEM WITH MOBILE DEVICE APPLICATIONS, the specification of which is incorporated by reference herein.

### TECHNICAL FIELD

This invention relates to mobile commerce, and in particular to a method, system and device for executing a mobile transaction using rewards and incentives.

### BACKGROUND OF THE INVENTION

Mobile commerce enables a consumer to utilize a mobile device to assist in purchasing an item. Typical mobile commerce applications that execute on mobile devices such as smartphones provide rudimentary functionality such as comparative shopping in which the device scans a UPC code to look up prices from various merchants. Some mobile commerce applications enable the consumer to complete a purchase transaction in a manner similar to using a standard desktop-based browser. These mobile commerce applications provide an extension of the desktop environment but do not take sufficient advantage of the mobile aspect of the mobile platforms in use today. In any event, mobile commerce applications do not provide a platform for utilizing previously acquired rewards and or incentives in making a mobile purchase transaction, but only allow the consumer to use his or her credit or debit card.

### SUMMARY OF THE INVENTION

The present invention addresses the shortcomings of the prior art and provides a mobile commerce platform that allows the consumer or user to use a mobile device for to accomplish some preliminary steps of the transaction process, and then interact with a point of sale terminal in a quick, efficient and robust manner. In accordance with the present invention, the user is able to assemble a payment solution before reaching the point of sale terminal, present that payment solution in an automated and mistake-free manner, and quickly complete the purchase transaction. In accordance with this invention, the user is able to execute the transaction in whole or in part using previously accumulated rewards and/or incentives. Since the user can accomplish certain steps preliminarily with the mobile device, time is saved during the point of sale interaction that would be otherwise unattainable, in particular when the use of purchase incentives and rewards are contemplated.

The present invention is therefore a method of a user executing a mobile transaction. A virtual wallet is generated on a mobile device, the mobile wallet including a reward value component. Information about an item desired to be purchased by the user is input to the mobile device. A proposed payment solution is generated from the virtual wallet that is sufficient to pay for the item and then presented to a point of sale terminal. The point of sale terminal then executes instructions from the proposed payment solution sufficient to execute payment for the item.

The virtual wallet may be generated on the mobile device by obtaining a reward account balance for each of a various reward accounts with which the user is registered, and then calculating the reward value component of the virtual wallet by adding the value of each reward account balance obtained. In one embodiment, the reward account balance for each of the various reward accounts is obtained by the mobile device communicating with an exchange server computer via a computer network, wherein the exchange server computer stores the reward account balances on behalf of the user. In an alternative embodiment, the reward account balance for each of the various reward accounts is obtained by the mobile device communicating with various reward server computers directly via a computer network to obtain from each of the reward server computers a reward account balance for each of the reward accounts. Optionally, the reward account balance obtained for each of the reward accounts may be displayed on the mobile device. The virtual wallet may also include an incentive component that includes at least one purchase incentive. The purchase incentive may be pushed to the mobile device without user interaction, or it may by pulled by the mobile device with user interaction. The purchase incentive may be based on the geographic location of the mobile device, the identification of the mobile device, a user profile stored on the mobile device, and/or the item to be purchased. Optionally, the value of the incentive may also be displayed on the mobile device.

Information about an item desired to be purchased by the user may be input to the mobile device by scanning a product bar code associated with the product (such as a UPC or QR Code) and using the scanned bar code to retrieve a purchase price for the item. In addition or in the alternative, the user may manually enter a purchase price for the item (and/or other information) into an input device on the mobile device such as a keypad (real or virtual).

A proposed payment solution may be generated from the virtual wallet that is sufficient to pay for the item by first applying a purchase incentive to the purchase price of the item. Then, an analysis is undertaken of the reward account balance for each of the reward accounts with respect to a preferred reward redemption priority. The proposed payment solution may then be displayed on the mobile device, and the user may then either modify or accept the proposed payment solution.

The payment solution may be presented to a point of sale terminal by generating a set of payment instructions for carrying out an associated payment component for payment for the item. In one embodiment, the payment instructions are then encoded into a bar code symbol such as a QR code, and the bar code symbol is rendered on the display of the mobile device and scanned at the point of sale terminal. In an alternative embodiment, the payment instructions my be read by the point of sale terminal with wireless communications such as NFC (near field communications), bluetooth, RF, and/or IR (infrared).

The point of sale terminal executes the instructions from the proposed payment solution sufficient to execute payment for the item by first executing an authorization process. In one embodiment, the point of sale terminal communicates with an exchange server computer in order to receive authorization for each of the payment instructions. The exchange server computer receives, for each of the payment instructions, a request from the point of sale terminal to authorize a portion of the purchase price associated with the payment instruction. For each of the payment instructions, the exchange server computer communicates with an issuer computer associated with the payment instruction and requests authorization for the associated payment instruction. In an alternative embodiment, the point of sale terminal communicates directly with the issuer computer associated with each payment instruction and requests authorization for the associated payment instruction.

This invention is carried out with a system for executing a mobile transaction, including a mobile device with input means, a display, wireless communications means, and a processor. The processor is programmed to generate a virtual wallet including a reward value component, input information about an item desired to be purchased, generate a proposed payment solution from the virtual wallet sufficient to pay for the item, and present the proposed payment solution to a point of sale terminal. The system of this invention also includes a point of sale terminal having input means, a display, communications means, and a processor programmed to execute instructions from the proposed payment solution sufficient to execute payment for the item.

The mobile device processor may be programmed to generate a virtual wallet including a reward value component by obtaining a reward account balance for each of various reward accounts with which the user is registered, and then calculating the reward value component of the virtual wallet by adding the value of each reward account balance obtained.

In one embodiment, the system additionally includes an exchange server computer including memory for storing reward account balances on behalf of the user. In this case, the mobile device processor is programmed to obtain a reward account balance for each of a plurality of reward accounts with which the user is registered by communicating with the exchange server computer via a computer network. In an alternative embodiment, the mobile device processor is programmed to obtain a reward account balance for each of a plurality of reward accounts with which the user is registered by communicating directly with the various reward server computers via a computer network to obtain from each of the reward server computers a reward account balance for each the reward accounts. Optionally, the mobile device processor may be further programmed to display the reward account balance obtained for each of the reward accounts. The virtual wallet may also include an incentive component that includes at least one purchase incentive. The purchase incentive may be pushed to the mobile device without user interaction, or it may by pulled by the mobile device with user interaction. The purchase incentive may be based on the geographic location of the mobile device, the identification of the mobile device, a user profile stored on the mobile device, and/or the item to be purchased. Optionally, the value of the incentive may also be displayed on the mobile device.

The mobile device may also include a camera, in which case the mobile device processor is programmed to input information about an item desired to be purchased by scanning with the camera a product bar code (such as a UPC or QR code) associated with the product and using the scanned bar code to retrieve a purchase price for the item. In addition or in the alternative, the user may manually enter a purchase price for the item (and/or other information) into an input device on the mobile device such as a keypad (real or virtual).

The mobile device processor may be programmed to generate generate a proposed payment solution from the virtual wallet sufficient to pay for the item by applying a purchase incentive to the purchase price of the item. The mobile device processor may be programmed to generate a proposed payment solution from the virtual wallet sufficient to pay for the item by analyzing the reward account balance for each of the reward accounts with respect to a preferred reward redemption priority. The proposed payment solution may then be displayed on the mobile device, and the user may then either modify or accept the proposed payment solution.

The mobile device processor may be programmed to present the proposed payment solution to a point of sale terminal by generating a set of payment instructions for carrying out an associated payment component for payment for the item. In one embodiment, the mobile device processor is further programmed to encode the payment instructions into a bar code symbol and render the bar code symbol on the display of the mobile device. In this case, the point of sale terminal is further programmed to scan the bar code symbol. In an alternative embodiment, the point of sale terminal is programmed to read the payment instructions with wireless communications means such as NFC (near field communications), bluetooth, RF, and/or IR (infrared).

The point of sale terminal may be programmed to execute instructions from the proposed payment solution sufficient to execute payment for the item by executing an authorization process. In one embodiment, the system further includes an exchange server computer. In this case, the point of sale terminal is programmed to execute the authorization process by communicating with the exchange server computer in order to receive authorization for each of the payment instructions, and transmitting for each of the payment instructions a request to the exchange server computer to authorize a portion of the purchase price associated with the payment instruction. The exchange server computer is then programmed to communicate with an issuer computer associated with each payment instruction and request authorization for the associated payment instruction. In an alternative embodiment, the point of sale terminal is programmed to communicate directly with the issuer computer associated with each payment instruction and request authorization for the associated payment instruction.

This invention also includes a mobile device for executing a mobile transaction, including input means, a display, wireless communications means, and a processor. The processor is programmed to generate a virtual wallet including a reward value component, input information about an item desired to be purchased, generate a proposed payment solution from the virtual wallet sufficient to pay for the item, and present the proposed payment solution to a point of sale terminal.

The mobile device processor may be programmed to generate a virtual wallet including a reward value component by obtaining a reward account balance for each of various reward accounts with which the user is registered, and then calculating the reward value component of the virtual wallet by adding the value of each reward account balance obtained. In one embodiment, the mobile device processor is programmed to obtain a reward account balance for each of a plurality of reward accounts with which the user is registered by communicating with an exchange server computer via a computer network. In an alternative embodiment, the mobile device processor is programmed to obtain a reward account balance for each of a plurality of reward accounts with which the user is registered by communicating directly with the various reward server computers via a computer network to obtain from each of the reward server computers a reward account balance for each the reward accounts. Optionally, the mobile device processor may be further programmed to display the reward account balance obtained for each of the reward accounts. The virtual wallet may also include an incentive component that includes at least one purchase incentive. The purchase incentive may be pushed to the mobile device without user interaction, or it may by pulled by the mobile device with user interaction. The purchase incentive may be based on the geographic location of the mobile device, the identification of the mobile device, a user profile stored on the mobile device, and/or the item to be purchased. Optionally, the value of the incentive may also be displayed on the mobile device.

The mobile device may also include a camera, in which case the mobile device processor is programmed to input information about an item desired to be purchased by scanning with the camera a product bar code (such as a UPC or QR code) associated with the product and using the scanned bar code to retrieve a purchase price for the item. In addition or in the alternative, the user may manually enter a purchase price for the item (and/or other information) into an input device on the mobile device such as a keypad (real or virtual).

The mobile device processor may be programmed to generate generate a proposed payment solution from the virtual wallet sufficient to pay for the item by applying a purchase incentive to the purchase price of the item. The mobile device processor may be programmed to generate a proposed payment solution from the virtual wallet sufficient to pay for the item by analyzing the reward account balance for each of the reward accounts with respect to a preferred reward redemption priority. The proposed payment solution may then be displayed on the mobile device, and the user may then either modify or accept the proposed payment solution.

The mobile device processor may be programmed to present the proposed payment solution to a point of sale terminal by generating a set of payment instructions for carrying out an associated payment component for payment for the item. In one embodiment, the mobile device processor is further programmed to encode the payment instructions into a bar code symbol and render the bar code symbol on the display of the mobile device. In an alternative embodiment, the mobile device is further programmed to transmit the payment instructions with wireless communications means such as NFC (near field communications), bluetooth, RF, and/or IR.

### BRIEF DESCRIPTION OF THE DRAWING

FIG. 1 is a block diagram of the main components of the invention;

FIG. 2 is an illustration of the presentation of the payment solution using a QR code;

FIG. 3 is a detailed block diagram of the mobile device used with this invention;

FIGS. 4-9 are various flowcharts illustrating the operation of the present invention;

FIG. 10 is a block diagram of the POS terminal used with the present invention;

FIG. 11 is an illustration of a display screen of the mobile device of the present invention.

FIG. 12 shows a flowchart of the geo-alerts and geo-fencing process of the mobile application;

FIG. 13 is a flowchart of a store check-in process of on aspect of the mobile application;

FIG. 14 is a flowchart of the receive offers process of the mobile application implemented in the present invention; and

FIG. 15 is a flowchart of the digital receipt processes of the mobile application implemented in the present invention.

### DESCRIPTION OF THE PREFERRED EMBODIMENTS

In accordance with the preferred embodiment of this invention, use of a mobile device enables a user to interact with a physical brick and mortar store in addition to a reward exchange system as described further herein, and gain advantages previously unavailable in the prior art as will now be described. In the embodiments described below, the user (consumer) has a mobile device such as a smartphone that has GPS capabilities as known in the art, and/or NFC (near field communications) capabilities as known in the art, or in some instances where indicated the device has neither of these capabilities. In this embodiment, the consumer is running an application known as the SWIFT Mobile App on his or her mobile device.

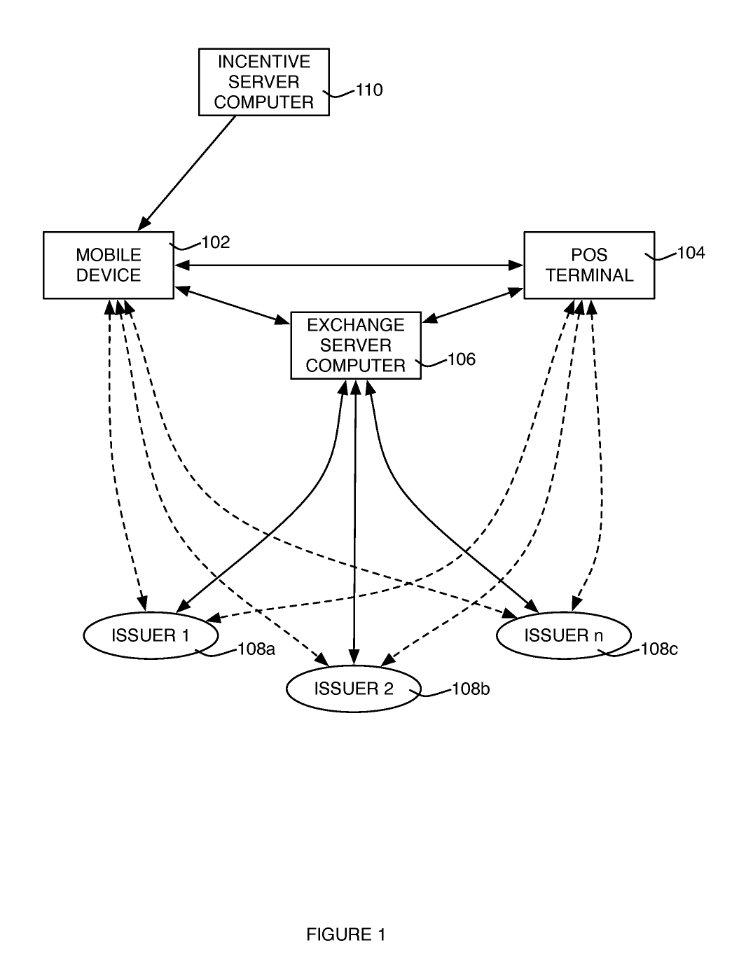

FIG. 1 is a block diagram of the main components of the invention. Shown generally are a mobile device 102 that is carried by a user (not shown), a point of sale (POS) terminal 104, an exchange server computer 106, and various issuers or issuer computers 108a, 108b, 108c (referred to generally as issuer computer 108). Also shown is an optional incentive server computer 110.

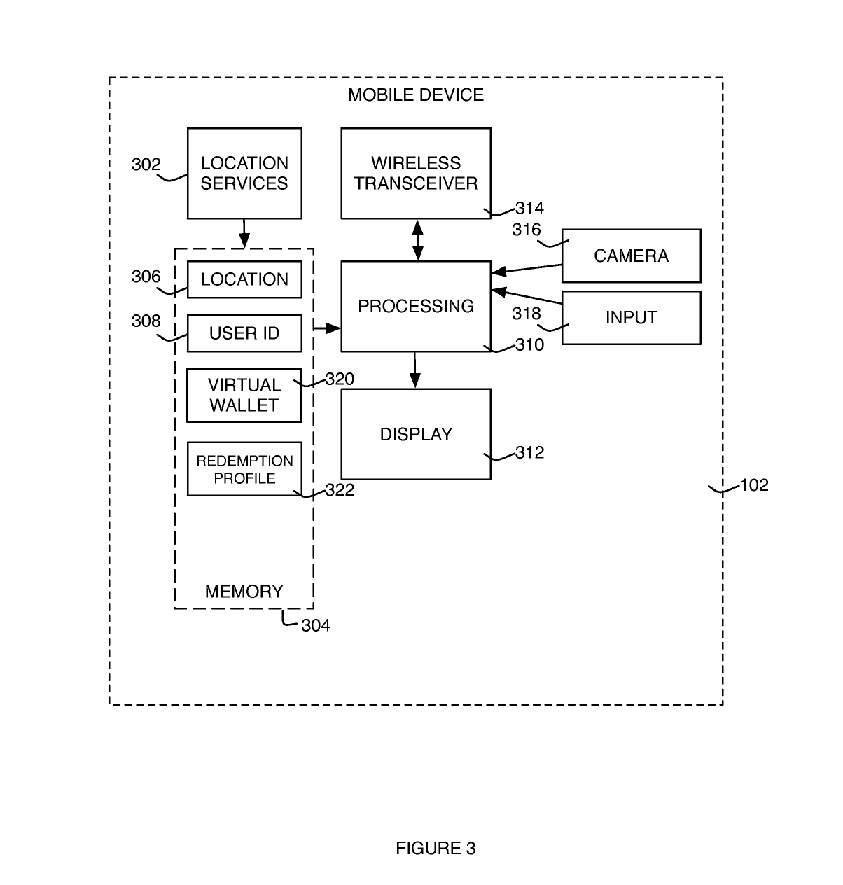

The mobile device 102 may be any type of mobile device capable of carrying out the functions that are described herein, the major functions of which are wireless communications, processing, memory and display. Typical examples of mobile devices 102 include but are not limited to a smartphone such as an IPHONE device, ANDROID device, or BLACKBERRY device, a tablet such as an IPAD, a laptop computer, and the like. Preferably the mobile device will also have GPS capabilities, which will aid in enabling the location services described herein. However, GPS capabilities are not necessary since location services may be attained in other ways such as cell phone triangulation, wi-fi hotspots, etc. With reference to FIG. 3, the mobile device 102 has a memory 304 for storing a user identification 308 identifying an associated user as well as location data 306. The location data 306 may be provided by location services 302, which typically would be a GPS receiver that functions to provide GPS coordinate data (latitude, longitude) of the mobile device 102 as well known in the art. Other types of location services may also be used instead of GPS, such as cell phone triangulation. A cell phone's location may be triangulated by communicating with several cell phone towers whose location is known, and then calculating an approximate location of the cell phone mobile device for use as location data 306. In the alternative, location services may be attained based on wi-fi hotspot location data, where the mobile device communicates via wi-fi with hot spots whose location is known, in a manner similar to cell phone tower triangulation. All of these location service techniques and methodologies are well known in the art and need not be further described herein. The memory 304 also stores a virtual wallet 320 and a redemption profile 322, both of which are discussed further herein.

The mobile device 102 also has wireless communications means such as a wireless transceiver 314 for performing various communications functions, such as when the mobile device 102 is a smartphone such as an IPHONE. Also shown in FIG. 3 is a processor or processing circuitry 310 for controlling the functionality of the mobile device as described herein, and input means which may include an input device(s) 318 for enabling the user to input data, select functions, etc. as well known in the art. The input device(s) may be hard buttons such as pushbuttons that are dedicated or programmable to select certain functions of the mobile device. Also shown is a display 312 for displaying various items as will be described further herein. As known in the art, the display 312 may be a touch screen display that incorporates input functionality as well such that the input means includes the touchscreen display. A camera 316 may also be provided that would enable to user to capture an image for input purposes (e.g. such as imaging a UPC bar code for product identification) as described in further detail below.

Also shown in FIG. 1 is an exchange server computer 106, which may for example be any type of general purpose computer executing software to carry out the functions of the present invention as will be described. The exchange server computer 106 will also have associated communications means that will enable it to communicate with the mobile device 102 such as via a wireless network as well known in the art. Also, the exchange server computer 106 communicates with the various issuer computers 108, such as via a computer network such as but not limited to the Internet (not shown). One of the many functions of the exchange server computer is to provide a platform for exchanging or trading reward points from various reward accounts stored on different reward server computers (which may be issuer computers 108), as further described in application Ser. No. 12/703,243 filed Feb. 10, 2010 entitled ONLINE REWARD POINT EXCHANGE METHOD AND SYSTEM, the specification of which is incorporated by reference herein, as well as my previous U.S. Pat. No. 6,594,640 issued Jul. 15, 2003 entitled SYSTEM FOR ELECTRONIC BARTER, TRADING AND REDEEMING POINTS ACCUMULATED IN FREQUENT USE REWARD PROGRAMS. The functionality of the exchange server computer 106 in the context of the present invention will be fully described further herein.

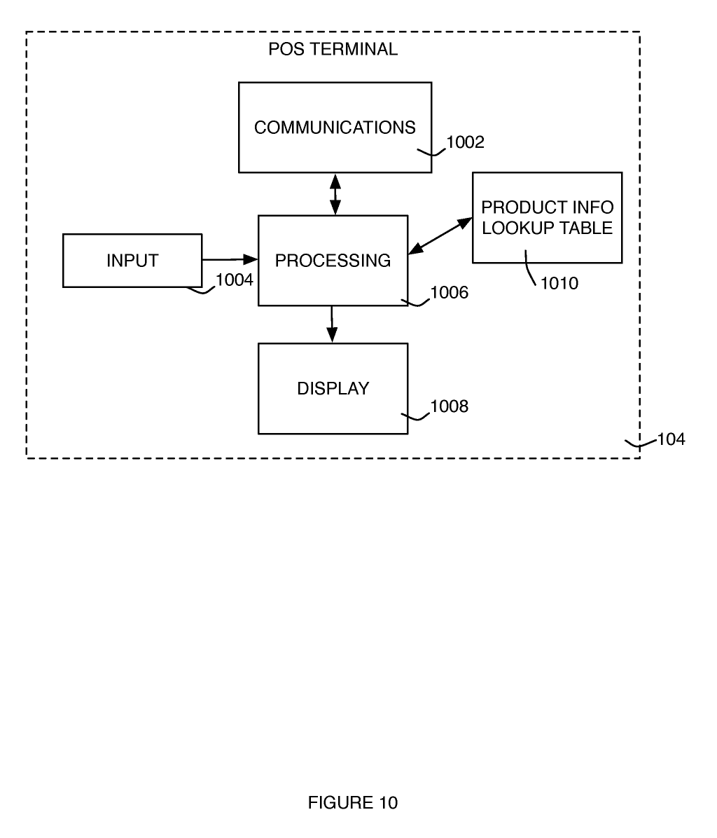

The POS terminal 104 is typically a computer terminal located at a physical merchant store (so-called brick and mortar store), and in the prior art functions to enable a cashier to perform product checkout and payment services (e.g. scan product codes, look up prices and other product information, receive payment in cash and/or credit cards, etc). The POS terminal 104, as shown in further detail in FIG. 10, has a communications means 1002, an input means 1004, a processor 1006, and a display 1008. Optionally a product information lookup table 1010 may be stored at the POS terminal 104, although it may be located elsewhere such as in association with a store network. The communications means may be wireless and/or wired, and (depending on the embodiment) enables the POS terminal 104 to communicate with the various issuers 108, the exchange server computer 106, and the mobile device 102 as will be explained in further detail below (directly or via an associated merchant computer or network). The input means 1004 may be a keyboard, mouse, bar code scanner or the like, to enable data capture and input as will be described. The processor 1006 is programmed in accordance with the invention as will be further described. The POS terminal 104 of the present invention performs additional functionality in concert with the mobile device 102 as will be fully described further herein.

Issuer computers 108 are computers that are operated on or on behalf of various issuers. Issuers in this context hold value on behalf of a user and or extend credit on behalf of the user, and will authorize purchase transactions with merchants such that the issuer will agree to pay the merchant on behalf of the user and subsequently settle that transaction with the user based on one or more of various financial instruments. Thus, issuers may be credit issuers such as credit card companies such as AMERICAN EXPRESS or VISA, which issue credit that is used in transactions with merchants as well known in the art. Issuers may also be financial institutions that hold monetary funds on behalf of a user, such as banks, and that operate debit card transactions against those funds. Similarly, issuers may provide stored value cards or accounts wherein funds are deposited in an account for subsequent use. Issuers may also be entities that issue or otherwise hold reward points on behalf of a user, thus storing value for that user in the form of reward points. In this context, AMERICAN EXPRESS is also an issuer since it issues MEMBERSHIP REWARDS points for its users when the users execute certain transactions such as making purchases with an AMERICAN EXPRESS card. Thus, an issuer in this embodiment of the invention is a party with whom the merchant will look for payment, and subsequently settle with the user in accordance with the financial arrangement in place with that user.

POS terminals 104 that are operated on behalf of a merchant (not shown) may interact with issuer computers 108 via a computer network such as the Internet and/or a proprietary network such as a credit card network as known in the art in order to request and receive authorization for the user to make a purchase using an instrument of that issuer (e.g. credit card, debit card, check). In this system, the issuer may also be a reward issuer that will agree to tender payment to the merchant associated with the POS terminal if requested by a user, and then reduce the user's reward points in their account by a corresponding amount. For example, if a user specifies that issuer1 108a (AMERICAN EXPRESS for example) should redeem 10,000 of the user's reward points, then a corresponding value (e.g. $100) would be conveyed to the merchant associated with the POS terminal 104 as part of that transaction. This will be explained in further detail below.

Also as explained further below, reward redemption transactions may be mediated by the exchange server computer 106. In one embodiment, the issuers have contractual relationships with the exchanger server computer 106 so that reward points are redeemed and consideration is conveyed to the exchange server computer, which in turn will make payment to the POS terminal 104. One advantage to this embodiment is that it is not necessary for each issuer to have preexisting arrangements with each merchant, only that each merchant and each issuer have an agreement for reward point redemption with the exchange server 106. This is also discussed in my U.S. Pat. No. 8,078,496 issued Dec. 13, 2011 entitled METHOD AND SYSTEM FOR IMPLEMENTING A SEARCH ENGINE WITH REWARD COMPONENTS AND PAYMENT COMPONENTS.

The mobile device 102 communicates with the issuers 108 and/or the exchange server 106 via wireless and wired communications networks as known in the art. The mobile device 102 may also interact with the POS terminal in various wireless means as will be explained in further detail below.

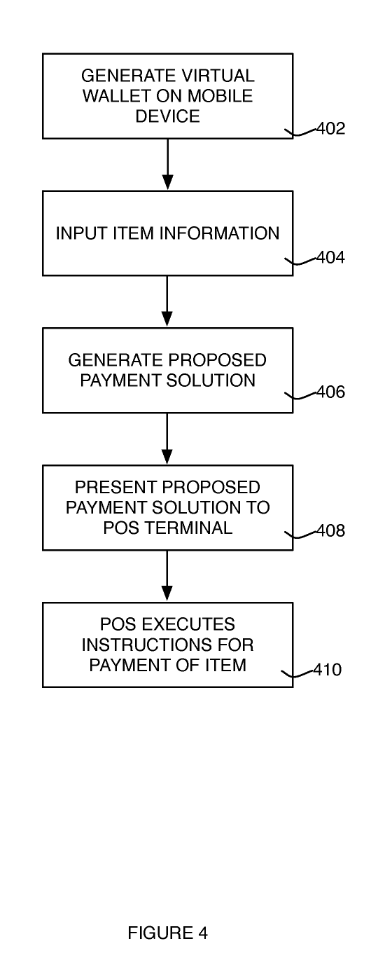

With reference to the main flowchart of FIG. 4, the processor is programmed to generate a virtual wallet including a reward value component at step 402, input information about an item desired to be purchased at step 404, generate a proposed payment solution from the virtual wallet sufficient to pay for the item at step 406, and present the proposed payment solution to the point of sale terminal at step 408. The POS terminal executes the instructions for payment of the item at step 410.

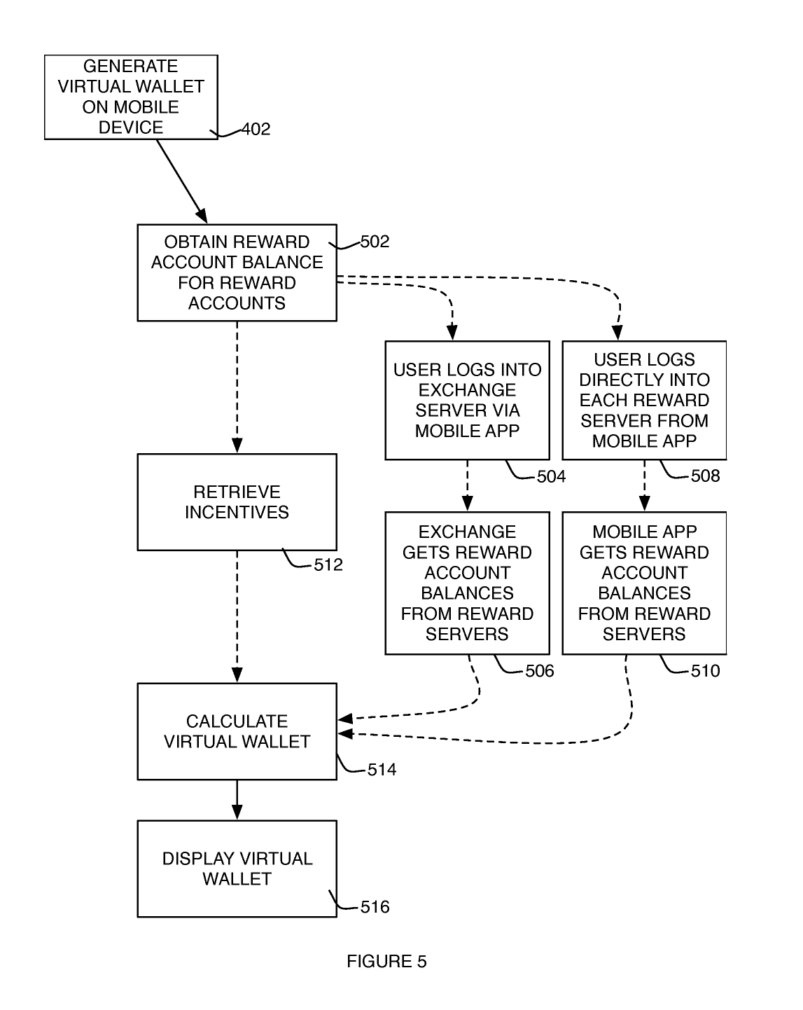

FIG. 5 illustrates the steps executed in order to generate the virtual wallet on the mobile device. The virtual wallet functions similar to the real wallet paradigm in that it holds various components of value, notably a reward component and optionally an incentive component. The reward value component represents the value of all of the user's reward programs at any given time, which is a function of the balance in each account as well as the value of each point that is provided by the reward account issuer. In order to generate the reward value component of the virtual wallet, the mobile device obtains a reward account balance for each of various reward accounts with which the user is registered, and then calculates the reward value component of the virtual wallet by adding the value of each reward account balance obtained.

In one embodiment, the mobile device uses the services of the exchange server computer as shown in FIG. 1. As described in the '243 application and '640 patent set forth above, the exchange server computer interoperates with various issuers 108 (reward issuers in particular) in order to perform reward point exchanges at the direction of the user. As part of this process, the exchange server computer 106 is able to login to each reward account of the user located at each reward server (i.e. issuer computer 108) and obtain reward account balance information for that user. For example, if the issuer1 108a is AMERICAN EXPRESS and the user has a MEMBERSHIP REWARDS account, then the balance of the user's MEMBERSHIP REWARDS is stored at the issuer1 computer 108a and provided to the exchange server computer 106 on request and authorization of the user. Similar transactions may occur with other issuers 108. As such, in this embodiment, the exchange server computer 106 becomes a central repository having a memory for storing all of the user's reward account balance information and can be easily accessed by the mobile device 102 to obtain that information as desired. Thus, in this embodiment, the user logs into the exchange server computer via an application executing on the mobile device at step 504, and the mobile device processor 310 is programmed at step 506 to obtain a reward account balance for each of the reward accounts with which the user is registered by communicating with the exchange server computer 106 via a computer network.

In an alternative embodiment, the mobile device processor 310 is programmed to obtain a reward account balance for each of the reward accounts with which the user is registered by communicating directly with the various issuer (reward server) computers 108 via a computer network to obtain from each of the issuer (reward server) computers a reward account balance for each of the reward accounts. Thus, at step 508 the user logs directly into each issuer (reward server) computer directly from the mobile application. This may be done in an automatic fashion by which the user's login credentials are pre-populated from the mobile device memory so that the user does not have to manually enter the logins each time the app is run. At step 510, the mobile device uses that login information in order to obtain the reward account balance from each of the issuer (reward server) computers 108.

At step 514 the mobile device processor calculates the total reward component of the virtual wallet by adding the value of each reward account (whether obtained through the exchange server and/or directly from each issuer computer 108), and at step 516 the mobile device may display the reward account balance obtained for each of the reward accounts and/or the total value of the virtual wallet.

The virtual wallet may also include an incentive component that includes at least one purchase incentive. Typically the purchase incentive may be a coupon that provides a purchase discount, but the incentive may be any instrument that drives traffic to particular merchant or to purchase a particular product, such as rebates and the like. The purchase incentive may be pushed by the incentive server computer 110 to the mobile device without user interaction, or it may by pulled by the mobile device from the incentive server computer 110 with user interaction. The purchase incentive may be based on the geographic location of the mobile device, wherein the location of the mobile device as indicated by the location services 302 (such as a GPS receiver), and the location data is transmitted to the incentive server computer 110. The incentive server computer 110 may then use the location of the mobile device 102 to determine an appropriate incentive to push to the mobile device (for example if the user is near a certain merchant location then the incentive server computer may push an incentive for that merchant to the mobile device).

In addition, the identification of the mobile device and/or the user may be transmitted to the incentive server computer 110 to be used in order to generate the purchase inventive. A user profile may be stored in memory 304 on the mobile device, which may provide purchase history to the incentive server computer 110 useful in generating an appropriate incentive. In some cases the user may scan the product code of an item to be purchased, and that information is sent to the incentive server computer to help generate the purchase incentive. All of these situations are discussed in further detail in my copending application Ser. No. 13/325,739 entitled METHOD AND SYSTEM FOR PROVIDING LOCATION-BASED INCENTIVES AND PURCHASE OPPORTUNITIES TO REWARD PROGRAM MEMBERS. If purchase incentives are stored in the memory of the mobile device, then the value of the incentive(s) may be calculated as an incentive component at step 512 and added to the virtual wallet at step 514.

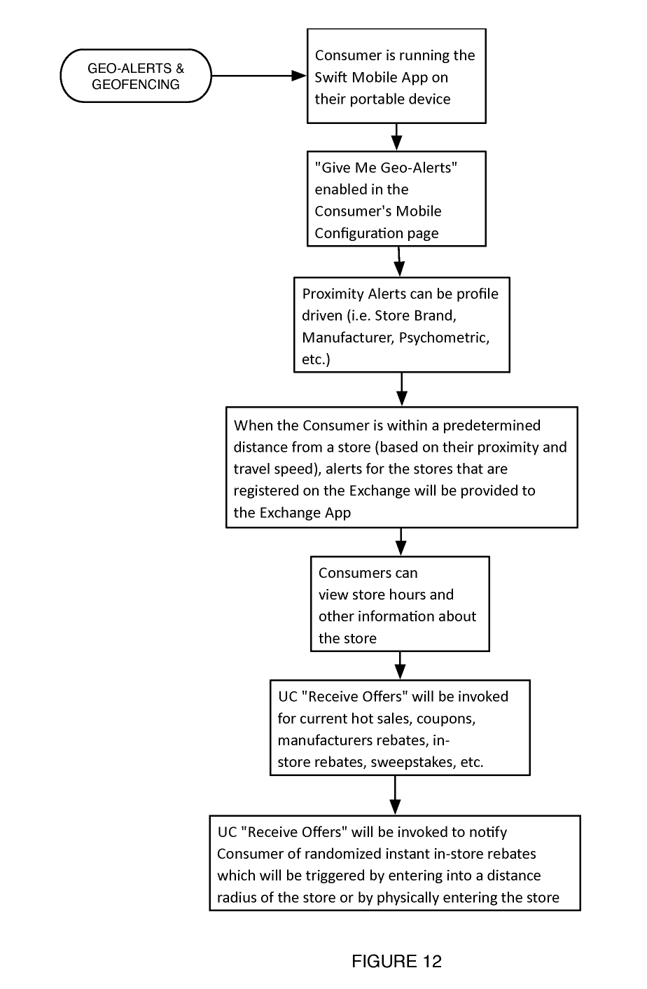

In another aspect of the incentive feature of this invention, FIG. 12 shows a flowchart of the geo-alerts and geo-fencing process of the mobile application implemented in the present invention. In this process, the SWIFT Mobile Application polls the GPS position of the device and provides appropriate alerts related to stores within their proximity. A feature referred to as “Give Me Geo-Alerts” is enabled in the settings or configuration page of the app. Proximity alerts can be profile driven (such as store brand, manufacturer, psychometrics, etc.). When the Consumer is within a predetermined distance from a store (based on their proximity and travel speed), alerts for the stores will be provided to the mobile app. Consumers can view store hours and other information about the store. “Receive Offers” will be invoked for current hot sales, coupons, manufacturers rebates, in-store rebates, sweepstakes, etc. “Receive Offers” will be invoked to notify the consumer of randomized instant in-store rebates which will be triggered by entering into a distance radius of the store or by physically entering the store.

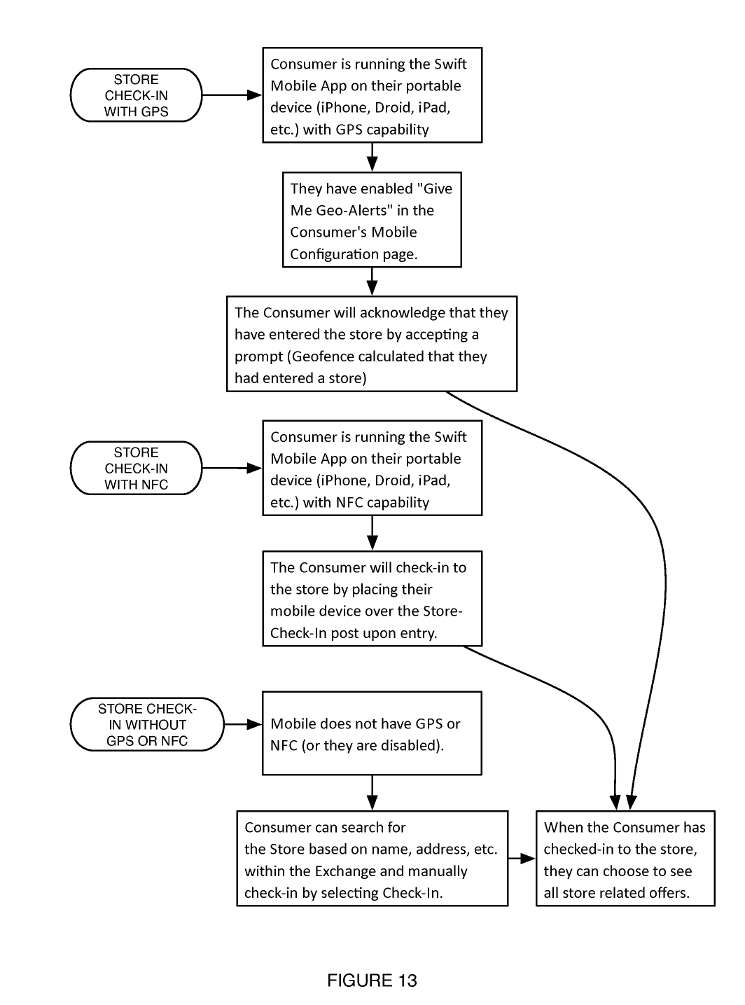

FIG. 13 is a flowchart of a store check-in process of one aspect of the mobile application implemented in the present invention. In one embodiment that uses the GPS function of the mobile device, a “Give Me Geo-Alerts” function is enabled in a configuration page of the user's mobile device. The user will acknowledge that he has entered the store location by accepting a prompt (a geofence application on the device calculates that the device has entered a store). When the user has checked-in to the store, he can choose to see all store related incentives and offers. In an alternative embodiment that uses the NFC function of the mobile device, the consumer will check-in to the store by placing the mobile device over a store check in post upon entry. When the user has checked-in to the store, he can choose to see all store related offers. In another embodiment in which the mobile device does not implement GPS or NFC, then the user can search for the store based on name, address, etc. within the mobile app and manually check-in by selecting a check-in option. Again, when the user has checked-in to the store, he can choose to see all store related incentives and offers. A user could also check-in to a store by scanning a QR code located at the store, for example at the entrance of the store. This would inform the application as to where the user is currently located.

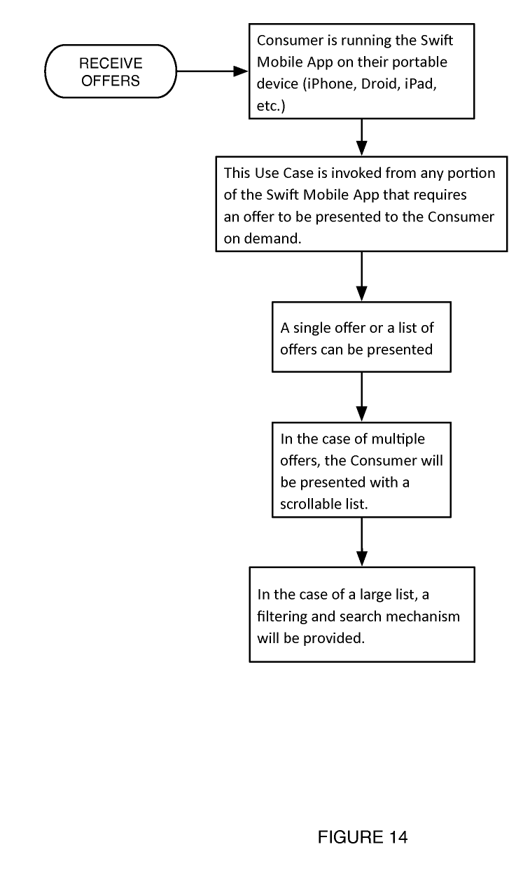

FIG. 14 is a flowchart of the receive offers process of the mobile application implemented in the present invention. This process may be invoked from any portion of the SWIFT Mobile App that requires an offer to be presented to the consumer on demand. A single offer or a list of offers can be presented. In the case of multiple offers, the consumer will be presented with a scrollable list. In the case of a large list, a filtering and search mechanism will be provided.

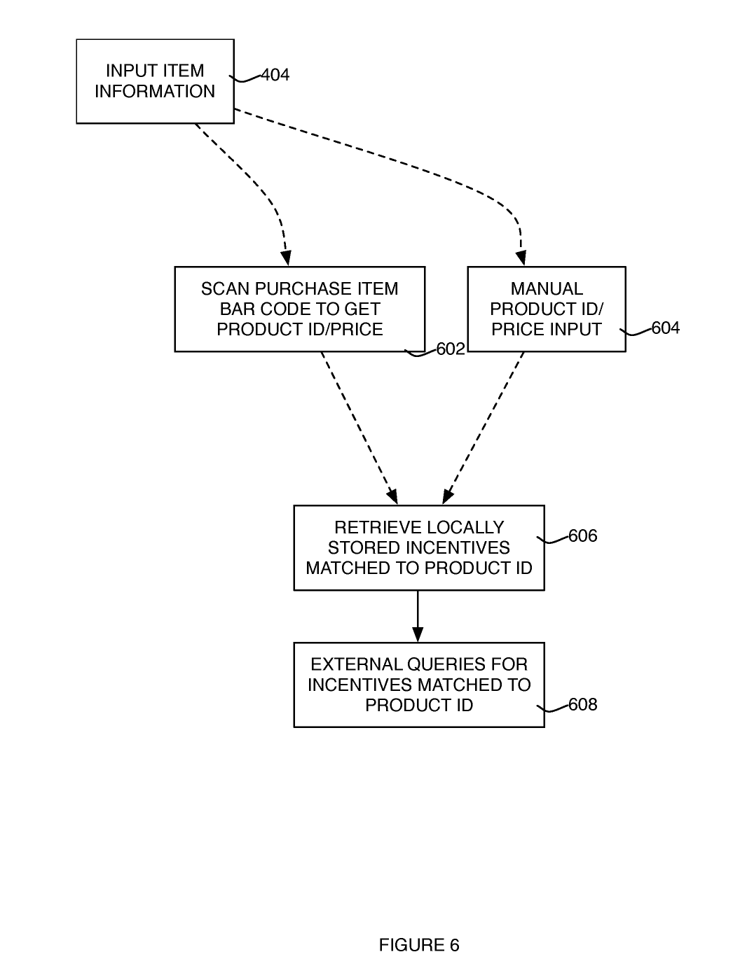

Referring to FIG. 6, the step 404 of inputting item information to the mobile device is now described in further detail. As the user is shopping at a merchant location, he will see an item that he wishes to purchase. Most if not all commercial products will have some sort of identifying bar code symbol, such as a UPC code (Universal Product Code) or a QR Code (Quick Response Code). The original purpose of the UPC is to provide an easy way for a cashier to obtain pricing information for a product and perform product checkout by simply scanning the cod eat the POS terminal. As known in the art, by scanning the UPC code, a lookup is performed in a product information lookup table or database 1010 that may be located at the POS terminal as shown in FIG. 10, (or located on a store network) to get the price as well as other identifying information. This methodology has been advanced to the point of a user being able to run an app on a mobile device, image the bar code with the camera function of the mobile device, and connect with a server computer on the Internet or elsewhere that performs a comparative shopping function by searching the item at various merchants and returning the prices from those merchants, thus enabling the user to easily compare merchants' prices for that product. This functionality may be extended in the present invention so that the user can obtain pricing information about an item and prepare for checkout as he views the items in the store.

Thus, the mobile device 102 may also include a camera 316 (see FIG. 3), in which case the mobile device processor 310 is programmed to input information about an item desired to be purchased by scanning with the camera 316 a product bar code (such as a UPC or QR code) associated with the product and using the scanned bar code to retrieve a purchase price for the item at step 602. The purchase price may be retrieved from the product information lookup table 1010 located at the POS terminal or on a network, whereby the mobile device is granted access to that product information lookup table 1010 based on a login procedure with the merchant, a real-time request, etc. The location of the mobile device may be transmitted by the mobile device to the POS terminal or an associated server computer so that it is aware that the mobile device is in proximity of the store and grants it access to the pricing information in table 1010 based on such proximity. This may be useful in a self-checkout situation as well. In addition or in the alternative, the user may manually enter a purchase price for the item (and/or other information) into an input device on the mobile device such as a keypad (real or virtual) at step 604.

At step 606 of FIG. 6, the mobile device processor 310 may retrieve locally stored incentives that are matched to the product identification and/or the merchant, and/or are otherwise applicable to the intended purchase. These incentives may be obtained from the user's virtual wallet 320 in memory 304. For example, if the user's virtual wallet contains an incentive for a $5 coupon off of a SONY DVD Player, and the user scans a UPC on a SONY DVD Player box, then the virtual wallet 320 is searched for a matching incentive and that $5 coupon is retrieved from memory and optionally displayed on the screen so that the user is aware he may receive the $5 discount to purchase that item. This process may also retrieve incentives that are not matched to the product scanned but related to it. For example, if the user scans a UPC for a DVD player from a competing merchant (e.g. a PANASONIC DVD Player), the process may retrieve and display the SONY incentive in an effort to get the user to switch to a SONY product rather than purchase the PANASONIC product. Algorithms such as this may be implemented as desired by the system designer.

In addition to searching for an retrieving locally stored incentives from the virtual wallet 320, the mobile device processor 310 may be programmed to perform external queries for incentives matched to the product that was scanned at step 608. In this mode various searches may be made, such as a general search on the Internet or a directed search to a dedicated computer such as the incentive server computer 110.

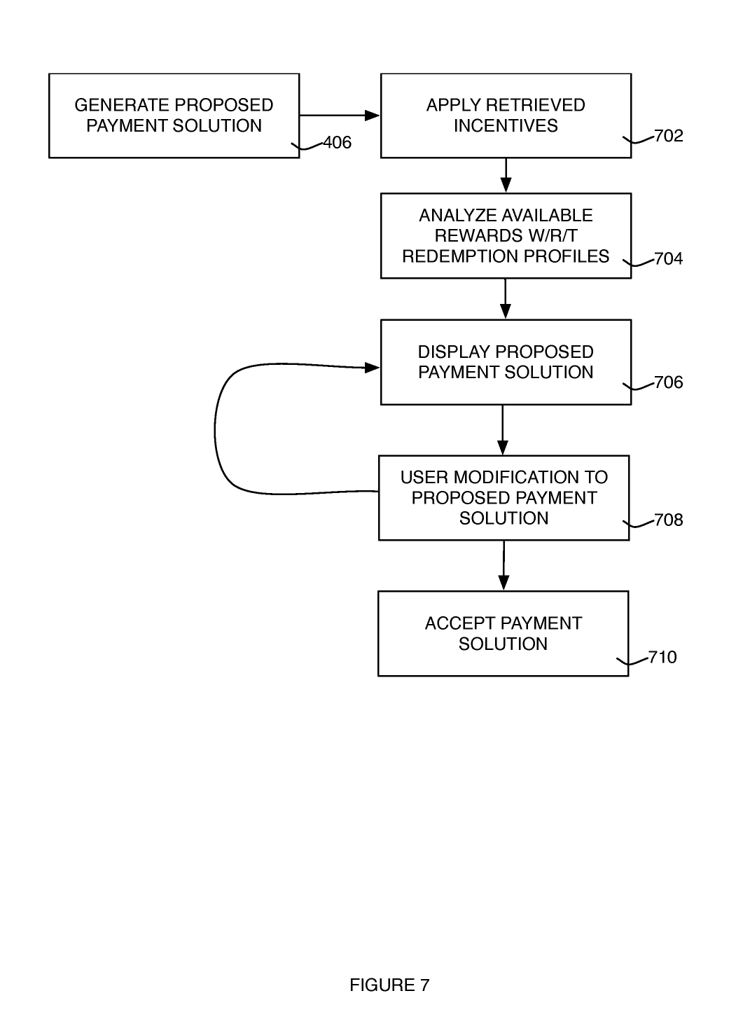

The mobile device processor may be programmed to generate a proposed payment solution from the virtual wallet 320 sufficient to pay for the item at step 406 by first applying any retrieved purchase incentive(s) to the purchase price of the item at step 702 (see FIG. 7). This will provide an adjusted purchase price if the incentive is a discount coupon for example. Next, at step 704, the mobile device processor analyzes the reward account balance for each of the available reward accounts with respect to a redemption profile 322, which is obtained from the memory 304. The redemption profile 322 may include a preferred reward redemption priority which sets up rules regarding a proposed redemption scenario.

For example, a rule may established that provides for redemption of points having highest trading value over all others. In this case, for example, if issuer1 is paying two cents for each point redeemed and all other issuers are only paying one cent for each point redeemed, then this rule would provide for the redemption of all of issuer1 points before looking to redeem any other issuer's points. Another rule example is to give priority to a preferred marketing partner of the merchant at which the user is located. In this case, for example, if the user is located at a MACYS store, and MACYS has a marketing agreement with CHASE VISA to use their points over all others, then the user's CHASE VISA points would be given priority in the proposed redemption scenario. Another rule example is to give priority to those reward accounts having the lowest number of points, or to give priority to those reward accounts having the highest number of points, or to give priority to those reward accounts having the lowest total value, or to give priority to those reward accounts having the highest value, etc. Thus, any rules may be established by the merchant, issuers, and/or user as may be desired.

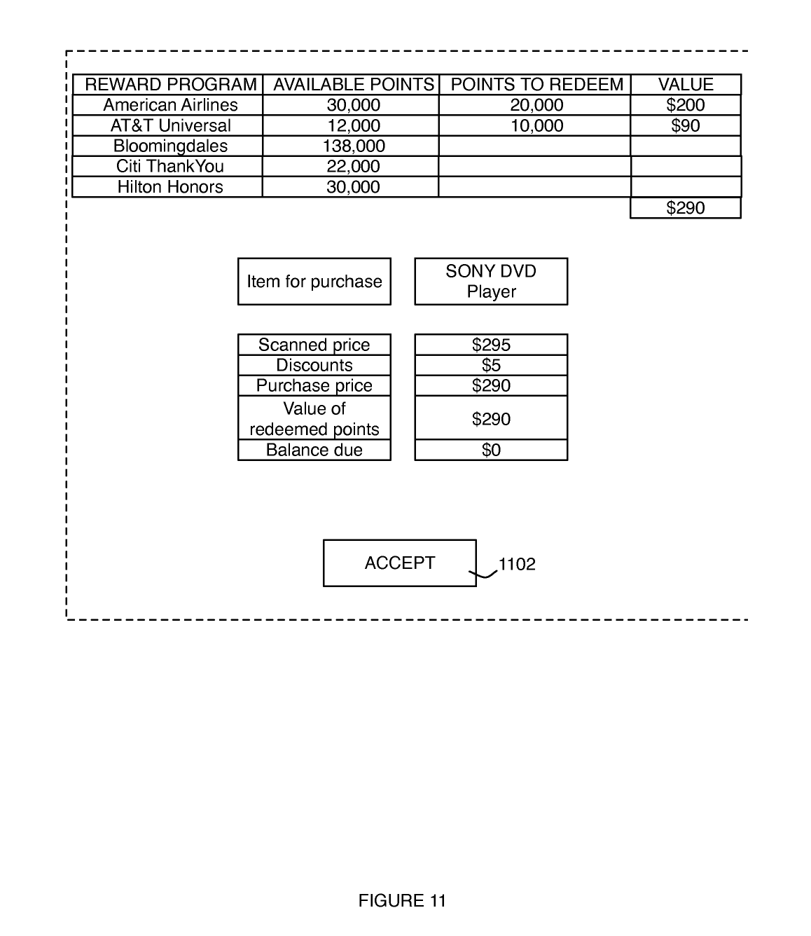

After the mobile device processor 310 analyzes the available rewards from the virtual wallet 320 with respect to the rules in the preferred reward redemption priority of redemption profile 322, the proposed payment solution is displayed to the user at step 706. An example of this is shown in FIG. 11. In this example, the user has 30,000 points in his AMERICAN AIRLINES reward account and the rule implemented has given priority to that issuer since it is a marketing partner of the merchant where the user is making the purchase. Another rule has been invoked that caps the maximum amount of redemption per transaction to 20,000 points, so the proposed payment solution suggests that 10,000 points from AT&T be used since the redemption value is $90 and that is what is left on the balance to pay for the selected DVD player, after the $5 incentive is applied. So, the proposed payment solution here provides for the redemption of 20,000 AA points and 10,000 AT&T points to pay for the DVD player selected by the user.

Thus, the mobile device processor has analyzed the user's available reward points and the applicable rules and determined that an optimal reward scenario is to use 20,000 of his AA points and 10,000 of his AT&T points to pay for the selected item. However, the user may now modify this proposed payment solution as desired at step 708. For example, the user may want to use none of his AA points, and thus will use enter a desired modification by for example touching the touchscreen input of the mobile device. This may bring up a text entry box or drop down list into which the user can modify the points distribution for the redemption, and the displayed values will change accordingly. If certain redemptions are not allowed by the rules, then any proposed modification that runs counter to those rules would be disallowed. For example there may be a rule that requires use of a minimum amount of AA points, and if the user attempts to go below that amount it would be disallowed, greyed out, etc. as known in the art. Once the user is satisfied with the proposed payment solution displayed, he can accept it by pressing button 1102 at step 710.

In an alternative embodiment, particularly applicable to that case wherein the mobile device interacts at step 506 with the exchange server to obtain the reward account balances rather than directly communicating with the issuers, then the exchange server may also provide the proposed redemption solution in the same manner as described. This is also described in copending application Ser. No. 12/703,243 filed Feb. 10, 2010 entitled ONLINE REWARD POINT EXCHANGE METHOD AND SYSTEM. The proposed payment solution would be displayed on the mobile device display, and be modifiable and accepted as described above.

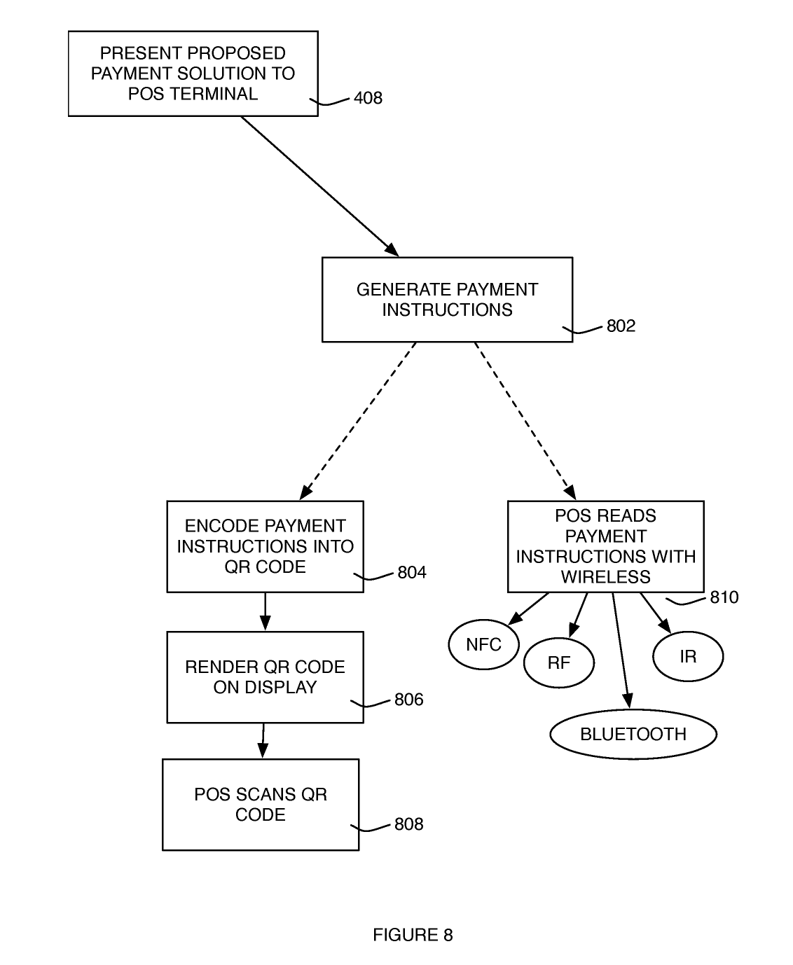

In the next main step 408, the mobile device processor is programmed to present the proposed payment solution to a point of sale terminal. This is shown in further detail in FIG. 8. A set of payment instructions suitable for carrying out an associated payment component for payment for the item is generated at step 802. The payment instructions will be used by the POS terminal to effect payment. Thus, in the example of FIG. 11, the payment instructions would request the POS terminal to (1) apply a discount coupon of $5 from the manufacturer, (2) redeem 20,000 points from the user's AA account at the AA issuer computer and collect $200, and (3) also redeem 10,000 points from the user's AT&T account at the AT&T issuer computer and collect $90. The format and protocol of these instructions is not critical as long as they convey the instructions as set forth above. One type of protocol is provided as follows:

START
/userID/itemID/
/paymentID/component-type/issuer/payment-amount/payment-
amount-type/value/. . .
END

wherein
userID=an identification of the user to the system, such as a user name or ID number
itemID=the scanned code type and code
paymentID=a unique number identifying the payment component
component-type=type of payment component, such as coupon, reward points, credit payment, etc.
issuer=name or other identifier of the issuer
payment-amount=the amount being tendered for the payment component
payment-amount-type=the type of the component
value=the value of the component

Note that the elipses indicate that multiple components may be added and the instruction set terminates with the END string.

Thus, in the present example, the payment instruction set would be as follows:

START
/user=1287477467/UPC=1347659099/
/664645/COUPON/SONY/5.00/USD/5.00/
/12345/REWARD/AA/20,000/AAPOINTS/200.00/
/67890/REWARD/AT&T/10,000/AT&TPOINTS/90.00/
END

This indicates that user with an ID of 1287477467 is purchasing an item whose UPC is 1347659099 (which may be looked up by the POS terminal for verification). The first payment component is a coupon, number 664645, which was issued by the manufacturer SONY and has a value of $5.00. The second payment component is a reward component assigned an ID number 12345, the issuer is AA, and 20,000 AA points are being redeemed for a value of $200. The third payment component is a reward component assigned an ID number 67890, the issuer is AT&T, and 10,000 AT&T points are being redeemed for a value of $90.

An exemplary credit card charge instruction would appear as follows:

/user=37178909763254/UPC=1235654324/
/76457378/CREDIT/CHASE-VISA/356.95/USD/356.95

which provides that the user having a credit card account number 37178909763254 with CHASE VISA is purchasing a product whose UPC is 1235654324 and requests authorization to charge $356.95 in USD.

An exemplary checking account payment instruction would appear as follows:

/user=3892876-092827635/UPC=657674647/
/9090900/CHECKING/BANKOFAMERICA/48.50/USD/48.50

which provides that the user having a checking account with Bank of America, routing number 3892876 and account number 092827635 is purchasing a product whose UPC is 657674647 and requests authorization to charge $48.50 in USD.

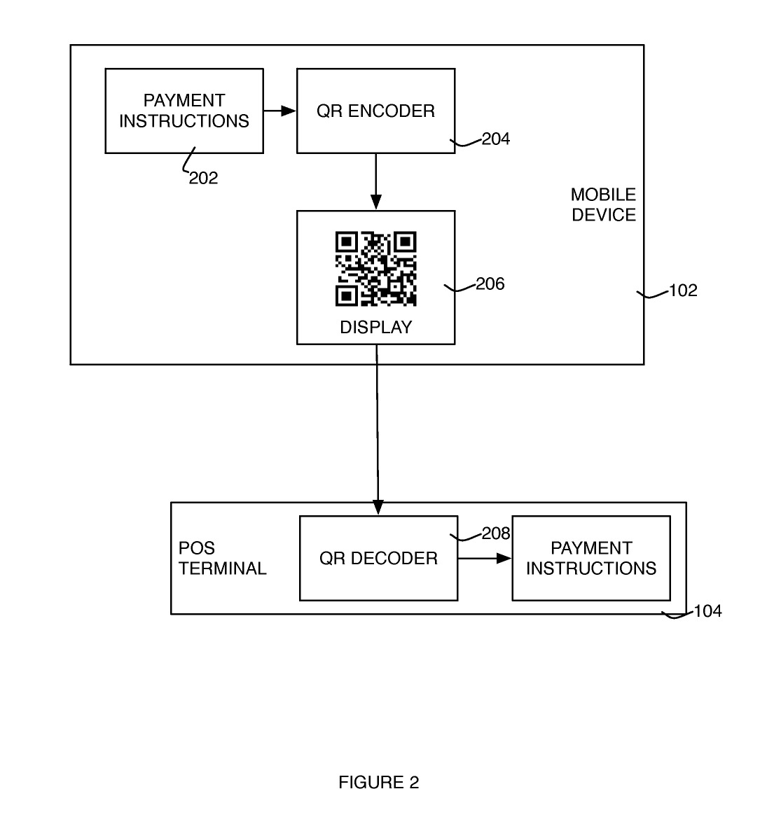

With reference again to the main embodiment, the mobile device processor at step 804 will next encode the payment instructions into a bar code symbol such as a QR code and render the bar code symbol on the display of the mobile device at step 806. A QR code may be used since it is robust and can contain much more data than a simple linear bar code. However, any type of code symbology may be used in the present invention. QR code encoder software is well known in the art and need not be described in any detail here. This is shown in FIG. 2, in which the payment instructions 202 are encoded by the QR encoder 204 into a QR code 206 that is shown on the display of the mobile device 102.

Next, the user will present the mobile device to a POS terminal 104, which will scan the QR code from the display at step 808. The POS terminal 104 is shown in FIG. 10, wherein the input means 1004 includes a bar code scanner such as a laser scanner, CCD imager, and the like, all as well known in the art. Reference is also made to FIG. 2, wherein the POS terminal 104 implements a QR decoder program 208 to decode the scanned QR code as well known in the art, and thus obtain the payment instructions 202 that were originally generated by the mobile device 102 as described above.

In an alternative embodiment, the point of sale terminal is programmed to read the payment instructions at step 810 with wireless communications means such as NFC (near field communications), bluetooth, RF, and/or IR (infrared).

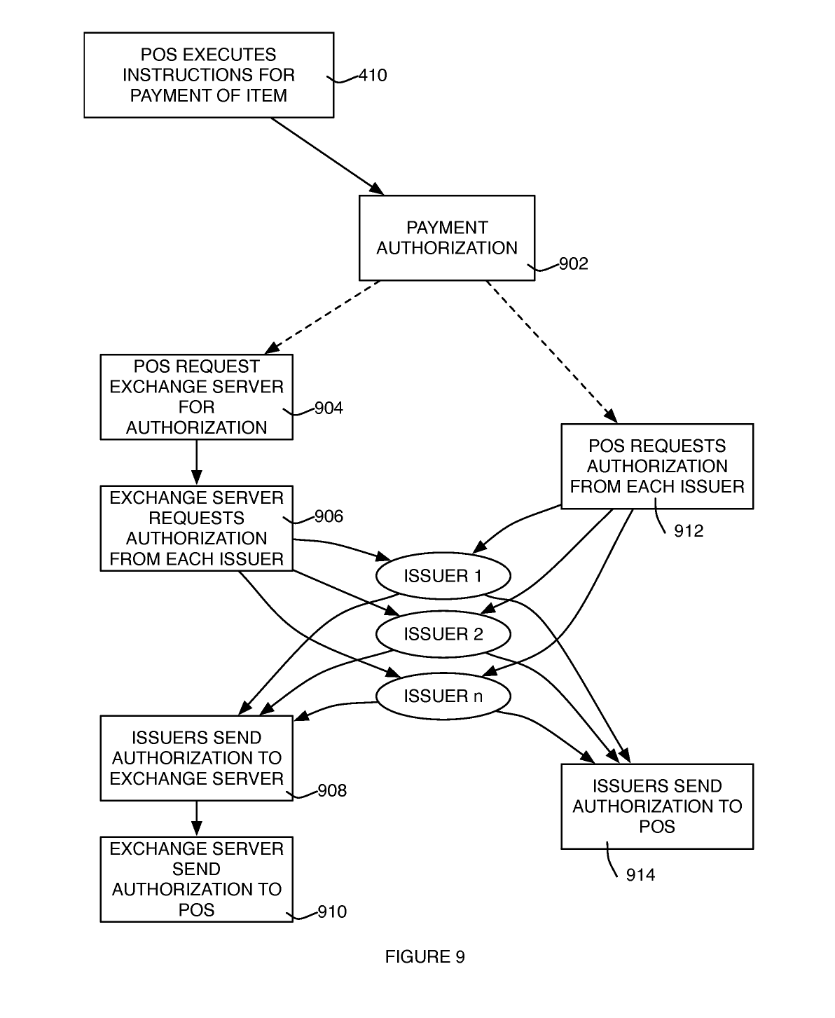

Once the POS terminal has obtained the payment instructions from the mobile device, it will execute the instructions from the proposed payment solution sufficient to execute payment for the item at step 410, shown in detail in FIG. 9. A payment authorization process begins at step 902. In one embodiment, the point of sale terminal is programmed to execute the authorization process by communicating with the exchange server computer in order to receive authorization for each of the payment instructions. At step 904, a request for authorization for each of the payment instructions is made to the exchange server computer in order to authorize those portions of the purchase price associated with the payment instructions. At steps 906 and 908, the exchange server computer communicates with the issuer computer that is associated with each payment instruction and requests authorization for the associated payment instruction. This may be preferred wherein the exchange computer has trading relationships already established with the various issuers involved in the process.

Thus, in the payment example above, the first instruction is

/664645/COUPON/SONY/5.00/USD/5.00/

which is a request to provide $5.00 off the purchase price. Authorization for this discount may be obtained from the issuer SONY, by sending the ID 664645, or alternatively that coupon may be present in a local POS terminal database that can be accessed without communicating with SONY.

The next instruction is

/12345/REWARD/AA/20,000/AAPOINTS/200.00/

which is a request to use 20,000 AA points from the account of user 1287477467. The exchange server computer will communicate with the issuer AMERICAN AIRLINES, in particular the reward server operated by AMERICAN AIRLINES, to get authorization for the redemption of 20,000 points from the account of user 1287477467 at a value of $200.

The final instruction is

/67890/REWARD/AT&T/10,000/AT&TPOINTS/90.00/

which is a request to use 10,000 AT&T points from the account of user 1287477467. The exchange server computer will communicate with the issuer AT&T, in particular the reward server operated by AT&T, to get authorization for the redemption of 10,000 points from the account of user 1287477467 at a value of $90.

Although not utilized in this example, a credit card issuer may also be included in any given payment instruction if desired. In that case, the credit card issuer (i.e. bank) would be contacted in the same manner for authorization for the requested credit, as well known in the art. This may be done of course by the POS terminal directly if desired since POS terminals are already designed to obtain credit authorization in the prior art.

Once the exchange server computer has obtained the required authorizations from the issuers, then it will send an authorization back to the POS terminal in step 910. In an alternative embodiment, the point of sale terminal is programmed to communicate directly with the issuer computers associated with each payment instruction and request authorization for the associated payment instruction at steps 912 and 914. In either case, if any of the individual authorization requests are denied, that will be noted and the transaction would be denied or allowed to be modified.

It is further noted that although this embodiment utilizes the POS terminal to request authorization from the various issuers, such authorization requests may be made from an associated device such as a merchant computer that is networked to the POS terminal as may occur in any larger retail establishment. In this case each POS terminal in the establishment would interoperate with the merchant computer to perform the functions discussed herein.

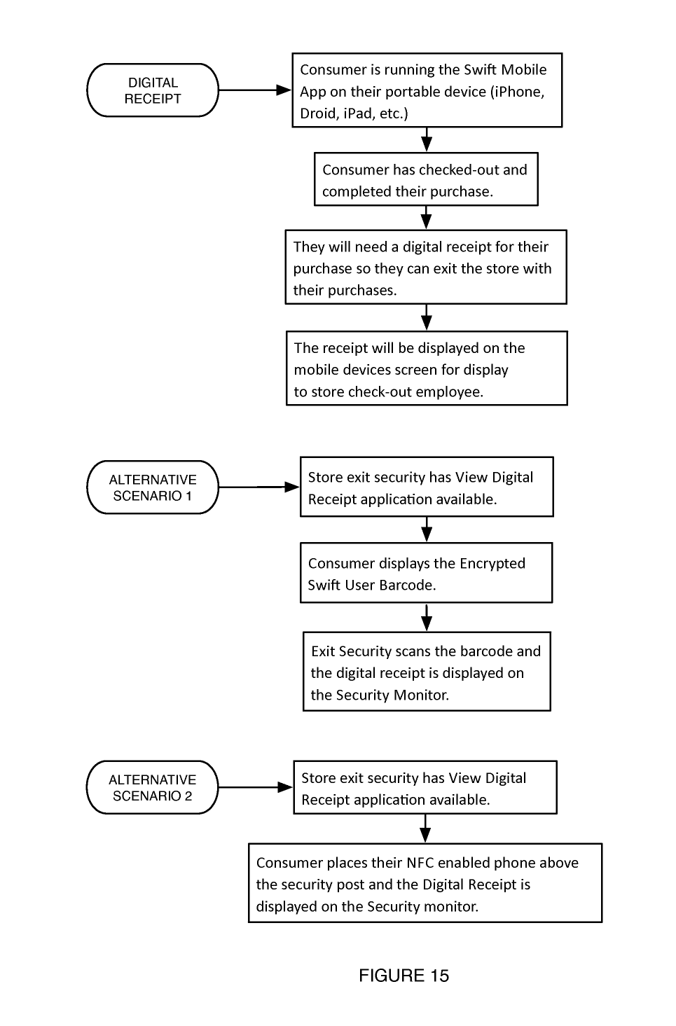

When the payment authorization process is complete, a digital receipt will be created as shown in FIG. 15. After the user has checked-out and completed the purchase(s), he will need a digital receipt so he can exit the store with the purchase(s). The receipt will be displayed on the screen of the mobile device for display to store check-out employee. This is especially useful in a self-checkout environment. In an alternative scenario, store exit security has a View Digital Receipt application available. The consumer displays the encrypted SWIFT barcode, and the exit security scans the barcode and the digital receipt is displayed on the security monitor. In another alternative scenario, store exit security scans the barcode and the digital receipt is displayed on the security monitor. The consumer places their NFC enabled phone above the security post and the digital receipt is displayed on the security monitor.

At some point subsequent to the purchase transaction, the parties will complete the transactions that have been authorized with a settlement process. For example, if one of the transactions is a redemption of 20,000 AA points from the issuer AMERICAN AIRLINES, then the transaction will be settled after the issuer reduces the number of points in the user's reward account by 20,000 points and conveys consideration of $200 to the POS terminal (or to the merchant that operates the POS terminal). All of the transactions occur in the same fashion. In the embodiment wherein the exchange server has procured the transaction authorizations, then the exchange server will settle the redemption transactions with each issuer and collect the consideration. The exchange server would subsequently convey consideration to the POS terminal (or to the merchant that operates the POS terminal).

As described, the present invention provides a mobile commerce platform that allows the consumer or user to use a mobile device for to accomplish some preliminary steps of the transaction process, and then interact with a point of sale terminal in a quick, efficient and robust manner. The user is able to assemble a payment solution before reaching the point of sale terminal, present that payment solution in an automated and mistake-free manner, and quickly complete the purchase transaction. The user is able to execute the transaction in whole or in part using previously accumulated rewards and/or incentives. Since the user can accomplish certain steps preliminarily with the mobile device, time is saved during the point of sale interaction that would be otherwise unattainable, in particular when the use of purchase incentives and rewards are contemplated.

What is claimed is:

1. A computer-implemented method of a user executing a mobile transaction comprising:
generating a virtual wallet on a mobile device comprising a reward value component;
inputting information about an item desired to be purchased;
generating a proposed payment solution from the virtual wallet sufficient to pay for the item;
presenting the proposed payment solution to a point of sale terminal; and
the point of sale terminal executing instructions from the proposed payment solution sufficient to execute payment for the item.

2. The method of claim 1 wherein the step of generating a virtual wallet on a mobile device comprising a reward value component comprises:
obtaining a reward account balance for each of a plurality of reward accounts with which the user is registered, and
calculating the reward value component of the virtual wallet by adding the value of each reward account balance obtained.

3. The method of claim 2 wherein the reward account balance for each of a plurality of reward accounts with which the user is registered is obtained by the mobile device communicating with an exchange server computer via a computer network, the exchange server computer storing the reward account balances on behalf of the user.

4. The method of claim 2 wherein the reward account balance for each of a plurality of reward accounts with which the user is registered is obtained by the mobile device communicating with a plurality of reward server computers via a computer network to obtain from each of the reward server computers a reward account balance for each of a plurality of reward accounts with which the user is registered.

5. The method of claim 1 further comprising the step of displaying on the mobile device the reward account balance obtained for each of the plurality of reward accounts.

6. The method of claim 1 wherein the virtual wallet further comprises an incentive component comprising at least one purchase incentive.

7. The method of claim 6 wherein the purchase incentive is pushed to the mobile device without user interaction.

8. The method of claim 7 wherein the purchase incentive is based on the geographic location of the mobile device.

9. The method of claim 7 wherein the purchase incentive is based on the identification of the mobile device.

10. The method of claim 7 wherein the purchase incentive is based on a user profile stored on the mobile device.

11. The method of claim 7 wherein the purchase incentive is based on the item to be purchased.

12. The method of claim 6 wherein the purchase incentive is pulled by the mobile device with user interaction.

13. The method of claim 6 further comprising the step of displaying the value of the incentive on the mobile device.

14. The method of claim 1 wherein the step of inputting information about an item desired to be purchased comprises scanning a product bar code associated with the product and using the scanned bar code to retrieve a purchase price for the item.

15. The method of claim 1 wherein the step of inputting information about an item desired to be purchased comprises manually entering a purchase price for the item into an input device on the mobile device.

16. The method of claim 6 wherein the step of generating a proposed payment solution from the virtual wallet sufficient to pay for the item comprises applying a purchase incentive to the purchase price of the item.

17. The method of claim 2 wherein the step of generating a proposed payment solution from the virtual wallet sufficient to pay for the item comprises analyzing the reward account balance for each of the plurality of reward accounts with respect to a preferred reward redemption priority.

18. The method of claim 17 further comprising the step of displaying the proposed payment solution on the mobile device.

19. The method of claim 18 further comprising the step of the user entering a modification of the proposed payment solution.

20. The method of claim 18 further comprising the step of the user accepting the proposed payment solution.

21. The method of claim 1 wherein the step of presenting the proposed payment solution to a point of sale terminal comprises generating a set of payment instructions, each of said payment instructions for carrying out an associated payment component for payment for the item.

22. The method of claim 21 further comprising the steps of
encoding the payment instructions into a bar code symbol;
rendering the bar code symbol on the display of the mobile device; and
scanning the bar code symbol at the point of sale terminal.

23. The method of claim 21 further comprising the steps of reading the payment instructions with wireless communications.

24. The method of claim 23 wherein the wireless communications comprises near field communications.

25. The method of claim 23 wherein the wireless communications comprises bluetooth communications.

26. The method of claim 23 wherein the wireless communications comprises RF communications.

27. The method of claim 23 wherein the wireless communications comprises infrared (IR) communications.

28. The method of claim 1 wherein the step of the point of sale terminal executing instructions from the proposed payment solution sufficient to execute payment for the item comprises an authorization process.

29. The method of claim 24 wherein the authorization process comprises
the point of sale terminal communicating with an exchange server computer in order to receive authorization for each of the payment instructions;
the exchange server computer receiving, for each of the payment instructions, a request from the point of sale terminal to authorize a portion of the purchase price associated with the payment instruction;
for each of the payment instructions, the exchange server computer communicating with an issuer computer associated with each payment instruction and requesting authorization for the associated payment instruction.

30. The method of claim 24 wherein the authorization process comprises, for each of the payment instructions, the point of sale terminal communicating with an issuer computer associated with each payment instruction and requesting authorization for the associated payment instruction.

31. A system for executing a mobile transaction comprising:
a mobile device comprising input means, a display, wireless communications means, and a processor programmed to
generate a virtual wallet comprising a reward value component;
input information about an item desired to be purchased;
generate a proposed payment solution from the virtual wallet sufficient to pay for the item; and
present the proposed payment solution to a point of sale terminal; and
a point of sale terminal comprising input means, a display, communications means, and a processor programmed to
execute instructions from the proposed payment solution sufficient to execute payment for the item.

32. The system of claim 31 wherein the mobile device processor is programmed to generate a virtual wallet comprising a reward value component by:
obtaining a reward account balance for each of a plurality of reward accounts with which the user is registered, and
calculating the reward value component of the virtual wallet by adding the value of each reward account balance obtained.

33. The system of claim 32 further comprising an exchange server computer comprising memory for storing reward account balances on behalf of the user, and wherein the mobile device processor is programmed to obtain a reward account balance for each of a plurality of reward accounts with which the user is registered by communicating with the exchange server computer via a computer network.

34. The system of claim 32 wherein the mobile device processor is programmed to obtain a reward account balance for each of a plurality of reward accounts with which the user is registered by communicating with a plurality of reward server computers via a computer network to obtain from each of the reward server computers a reward account balance for each of a plurality of reward accounts with which the user is registered.

35. The system of claim 31 further wherein the mobile device processor is further programmed to display the reward account balance obtained for each of the plurality of reward accounts.

36. The system of claim 31 wherein the virtual wallet further comprises an incentive component comprising at least one purchase incentive.

37. The system of claim 36 wherein the purchase incentive is pushed to the mobile device without user interaction.

38. The system of claim 37 wherein the purchase incentive is based on the geographic location of the mobile device.

39. The system of claim 37 wherein the purchase incentive is based on the identification of the mobile device.

40. The system of claim 37 wherein the purchase incentive is based on a user profile stored on the mobile device.

41. The system of claim 37 wherein the purchase incentive is based on the item to be purchased.

42. The system of claim 36 wherein the mobile device processor is further programmed to pull the purchase incentive with user interaction.

43. The system of claim 36 wherein the mobile device processor is further programmed to display the value of the incentive.

44. The system of claim 31 wherein the mobile device further comprises a camera, and wherein mobile device processor is programmed to input information about an item desired to be purchased by scanning with the camera a product bar code associated with the product and using the scanned bar code to retrieve a purchase price for the item.

45. The system of claim 31 wherein the mobile device processor is further programmed to input information about an item desired to be purchased by enabling manual entry via the input means of the purchase price for the item.

46. The system of claim 36 wherein the mobile device processor is programmed to generate a proposed payment solution from the virtual wallet sufficient to pay for the item by applying a purchase incentive to the purchase price of the item.

47. The system of claim 32 wherein the mobile device processor is programmed to generate a proposed payment solution from the virtual wallet sufficient to pay for the item by analyzing the reward account balance for each of the plurality of reward accounts with respect to a preferred reward redemption priority.

48. The system of claim 47 wherein the mobile device processor is programmed to display the proposed payment solution on the mobile device.

49. The system of claim 48 wherein the mobile device processor is further programmed to enable the user to enter a modification of the proposed payment solution.

50. The system of claim 48 wherein the mobile device processor is further programmed to enable the user to input an acceptance of the proposed payment solution.

51. The system of claim 31 wherein the mobile device processor is programmed to present the proposed payment solution to a point of sale terminal by generating a set of payment instructions, each of said payment instructions for carrying out an associated payment component for payment for the item.

52. The system of claim 51 wherein the mobile device processor is further programmed to:
encode the payment instructions into a bar code symbol; and
render the bar code symbol on the display of the mobile device; and wherein
the point of sale terminal is further programmed to scan the bar code symbol.

53. The system of claim 51 wherein the point of sale terminal is further programmed to read the payment instructions with wireless communications means.

54. The system of claim 53 wherein the wireless communications means comprises near field communications.

55. The system of claim 53 wherein the wireless communications means comprises bluetooth communications.

56. The system of claim 53 wherein the wireless communications means comprises RF communications.

57. The system of claim 53 wherein the wireless communications means comprises infrared (IR) communications.

58. The system of claim 31 wherein the point of sale terminal is programmed to execute instructions from the proposed payment solution sufficient to execute payment for the item by executing an authorization process.

59. The system of claim 54 further comprising an exchange server computer, and wherein the point of sale terminal is programmed to execute the authorization process by:
communicating with the exchange server computer in order to receive authorization for each of the payment instructions;
transmitting, for each of the payment instructions, a request to the exchange server computer to authorize a portion of the purchase price associated with the payment instruction; and wherein
for each of the payment instructions, the exchange server computer is programmed to communicate with an issuer computer associated with each payment instruction and request authorization for the associated payment instruction.

60. The system of claim 54 wherein the point of sale terminal is programmed to, for each of the payment instructions, communicate with an issuer computer associated with each payment instruction and request authorization for the associated payment instruction.

61. A mobile device for executing a mobile transaction comprising input means, a display, wireless communications means, and a processor programmed to
generate a virtual wallet comprising a reward value component;
input information about an item desired to be purchased;
generate a proposed payment solution from the virtual wallet sufficient to pay for the item; and
present the proposed payment solution to a point of sale terminal in order for the point of sale terminal to execute payment for the item.

62. The mobile device of claim 61 wherein the processor is programmed to generate a virtual wallet comprising a reward value component by:
obtaining a reward account balance for each of a plurality of reward accounts with which the user is registered, and
calculating the reward value component of the virtual wallet by adding the value of each reward account balance obtained.

63. The mobile device of claim 62 wherein the processor is programmed to obtain a reward account balance for each of a plurality of reward accounts with which the user is registered by communicating with an exchange server computer via a computer network.

64. The mobile device of claim 62 wherein the processor is programmed to obtain a reward account balance for each of a plurality of reward accounts with which the user is registered by communicating with a plurality of reward server computers via a computer network to obtain from each of the reward server computers a reward account balance for each of a plurality of reward accounts with which the user is registered.

65. The mobile device of claim 61 further wherein the processor is further programmed to display the reward account balance obtained for each of the plurality of reward accounts.

66. The mobile device of claim 61 wherein the virtual wallet further comprises an incentive component comprising at least one purchase incentive.

67. The mobile device of claim 66 wherein the purchase incentive is pushed to the mobile device without user interaction.

68. The mobile device of claim 67 wherein the purchase incentive is based on the geographic location of the mobile device.

69. The mobile device of claim 67 wherein the purchase incentive is based on the identification of the mobile device.

70. The mobile device of claim 67 wherein the purchase incentive is based on a user profile stored on the mobile device.

71. The mobile device of claim 67 wherein the purchase incentive is based on the item to be purchased.

72. The mobile device of claim 66 wherein the processor is further programmed to pull the purchase incentive with user interaction.

73. The mobile device of claim 66 wherein the processor is further programmed to display the value of the incentive.

74. The mobile device of claim 61 further comprising a camera, and wherein processor is programmed to input information about an item desired to be purchased by scanning with the camera a product bar code associated with the product and using the scanned bar code to retrieve a purchase price for the item.

75. The mobile device of claim 61 wherein the processor is further programmed to input information about an item desired to be purchased by enabling manual entry via the input means of the purchase price for the item.

76. The mobile device of claim 66 wherein the processor is programmed to generate a proposed payment solution from the virtual wallet sufficient to pay for the item by applying a purchase incentive to the purchase price of the item.

77. The mobile device of claim 62 wherein the processor is programmed to generate a proposed payment solution from the virtual wallet sufficient to pay for the item by analyzing the reward account balance for each of the plurality of reward accounts with respect to a preferred reward redemption priority.

78. The mobile device of claim 77 wherein the processor is programmed to display the proposed payment solution.

79. The mobile device of claim 78 wherein the processor is further programmed to enable the user to enter a modification of the proposed payment solution.

80. The mobile device of claim 78 wherein the processor is further programmed to enable the user to input an acceptance of the proposed payment solution.

81. The mobile device of claim 61 wherein the processor is programmed to present the proposed payment solution to a point of sale terminal by generating a set of payment instructions, each of said payment instructions for carrying out an associated payment component for payment for the item.

82. The mobile device of claim 81 wherein the processor is further programmed to:
encode the payment instructions into a bar code symbol; and
render the bar code symbol on the display of the mobile device.

83. The mobile device of claim 81 wherein the processor is further programmed to transmit the payment instructions with wireless communications means.

84. The mobile device of claim 83 wherein the wireless communications means comprises near field communications.

85. The mobile device of claim 83 wherein the wireless communications means comprises bluetooth communications.

86. The mobile device of claim 83 wherein the wireless communications means comprises RF communications.

87. The mobile device of claim 83 wherein the wireless communications means comprises infrared (IR) communications.
